(19) United States
(12) Patent Application Publication
(10) Pub. No.: US 2011/0280697 A1
(43) Pub. Date: Nov. 17, 2011

(54) Railroad Freight Car Loading Or Unloading

(76) Inventors: David Kun, Federal Way, WA (US); George Chen, Los Gatos, CA (US)

(21) Appl. No.: 13/105,897

(22) Filed: May 12, 2011

Related U.S. Application Data
(63) Continuation-in-part of application No. 12/777,278, filed on May 11, 2010.
Application No. 12/777,278 is a continuation-in-part of application No. 12/779,841, filed on Jul. 7, 2010.
Application No. 12/779,841 is a continuation-in-part of application No. 12/832,054, filed on Jul. 7, 2010.

(30) Foreign Application Priority Data
Nov. 2, 2010 (CN) 201010532105.3

(51) Int. Cl. B61D 47/00; B61D 3/18; B65G 63/00

(52) U.S. Cl. 414/333; 414/800

(57) ABSTRACT

The present invention relates to an apparatus and a method for railroad freight car loading or unloading. More specifically, the present invention discloses an apparatus for transferring freight among different modes of transportation including: a railway spur; zones disposed along said railway spur; an L-car disposed over said railway spur to carry said freight; an external propulsion mechanism disposed along said railway spur to move said L-car; sensors and actuators disposed in said zones to start and stop said L-car; connector rails disposed along said railway spur to direct said L-car onto roads adjacent to said railway spur, and a tractor disposed on rail to move one or more L-cars in a cluster or string. The present invention also relates to a method of transferring a container or a semi-trailer on and off an L-car with a straddling crane having portable scaffolding. The present invention also relates to a method of moving the L-car to a connector rail with a straddling crane having portable scaffolding.

### CLAIM OF PRIORITY

This patent application claims a benefit of priority of U.S. patent application Ser. No. 12/777,278 (filed on May 11, 2010), U.S. patent application Ser. No. 12/779,841 (filed on Jul. 7, 2010), and U.S. patent application Ser. No. 12/832,054 (filed on Jul. 7, 2010), all of which are currently pending.

### BACKGROUND OF THE INVENTION

1. Field of the Invention

The present invention relates to a field of transportation, and, more specifically, to an apparatus and a method for loading or unloading a railroad freight car.

2. Discussion of Related Art

A load being transported across a region may include freight having various sizes, shapes, and weights. The freight may be combined and packed in a container or semi-trailer for secure storage and reliable transportation.

Along a journey from origination points to destination points, the container or semi-trailer may be transferred among various modes of transportation, such as by tractor on road, by railroad freight car on rail, by ship on waterway, or by aircraft in air.

The present invention discloses a method of and an apparatus for moving the container or semi-trailer among different modes of transportation with a railroad freight car.

### SUMMARY OF THE PRESENT INVENTION

Accordingly, an object of the present invention is to transfer a container or semi-trailer among various modes of transportation with an L-car of the present invention.

Another object of the present invention is to propel the L-car from overhead or below a railway spur.

Another object of the present invention is to move the L-car from a main line to a side track with a connector rail that is removable or pivot able.

Yet another object of the present invention is to pivot an L-car on, or over, a plate across a platform that is underlying the rail of a side track.

The foregoing and other objects of the present invention are achieved with a system of the present invention that may include a connector rail.

Still another object of the present invention is to tilt a deck of an L-car of the present invention with a landing gear or a jack.

Yet another object of the present invention is to extend or retract a landing gear of an L-car.

Yet another object of the present invention is to load or unload a container or semi-trailer to or from an L-car of the present invention.

The foregoing and other objects of the present invention may be accomplished with an L-car of the present invention that may include a deck, a dolly attached below a rear section of the deck, a landing gear attached below a mid-section of the deck, a fixture attached below a front section of the deck, and a jack attached below the front section of the deck.

According to an aspect of the present invention, an apparatus is disclosed for transferring freight among different modes of transportation comprising: a railway spur;

zones disposed along said railway spur;
an L-car disposed over said railway spur to carry said freight;
an external propulsion mechanism disposed along said railway spur to move said L-car;
sensors and actuators disposed along said railway spur to start and stop said L-car in said zones; and
connector rails disposed along said railway spur to direct said L-car onto roads adjacent to said railway spur.

Preferably, said zones comprise a first set of zones disposed in parallel along said railway spur

Preferably, said first set of zones comprises a loading zone and an unloading zone.

Preferably, said zones comprise a second set of zones disposed in series along said railway spur.

Preferably, said second set of zones comprises a shared entry zone and a shared exit zone.

Preferably, said L-car comprises:

a deck to support said freight wherein said freight comprises a container or semi-trailer;
a dolly disposed below a rear section of said deck;
a landing gear disposed below a mid-section of said deck;
a fixture disposed below a front section of said deck; and
a jack disposed below said front section of said deck.

Preferably, said apparatus further comprises a hinge disposed at said mid-section of said deck of said L-car.

According to another aspect of the present invention, there is provided a method of transferring a container with an L-car comprising:

separating said L-car from a first cluster or string of L-cars on an arriving track;
moving said L-car along a railway spur to an entry zone;
stopping said L-car at said entry zone;
switching said L-car to a first connector rail;
pivoting said L-car to said first connector rail with a straddling crane, said straddling crane comprising a portable scaffolding;
moving said L-car along said first connector rail to a loading zone;
loading a container onto said L-car with said straddling crane;
switching said L-car to a second connector rail;
pivoting said L-car to said second connector rail with said straddling crane;
moving said L-car along said second connector rail to an unloading zone;
unloading said container from said L-car with said straddling crane;
moving said L-car along said railway spur to an exit zone;
stopping said L-car at said exit zone;
assembling said L-car into a second cluster or string of L-cars on a departing track; and
pulling said second cluster or string with a tractor disposed on rail.

Preferably, said moving said L-car along said railway spur to said entry zone is performed by an external propulsion mechanism.

Preferably, said unloading said container from said L-car comprises tilting a deck of said L-car and moving said container off said deck onto a road disposed adjacent to said railway spur.

The system of the present invention will be more completely understood from the following detailed description of the present invention taken in conjunction with the drawings.

### BRIEF DESCRIPTION OF THE DRAWINGS

FIG. 1 shows a schematic overhead view of railway spur to transfer a container or semi-trailer according to an embodiment of the present invention.

FIG. 2 shows a schematic elevation view of an L-car with a dolly, a landing gear that folds backwards, a fixture, and a jack according to an embodiment of the present invention.

FIG. 3 shows a schematic elevation view of an L-car with a dolly, a landing gear that folds forwards, a fixture, and a jack according to an embodiment of the present invention.

FIG. 4 shows a schematic elevation view of an L-car with a dolly, a landing gear, a deck with a hinge or joint near a mid-section, a fixture, and a jack according to an embodiment of the present invention.

FIG. 5A shows an L-car dolly with a swiveling assembly and multiple wheels according to an embodiment of the present invention.

FIG. 5B shows an L-car landing gear having a mini-dolly with a swiveling assembly and multiple wheels according to an embodiment of the present invention.

FIGS. 6A-6B shows a deck with two layers according to various embodiments of the present invention.

FIG. 7 shows a schematic elevation view of L-cars assembled in a cluster or string in at rain according to an embodiment of the present invention.

FIG. 8A shows a schematic elevation view of an L-car with an overhead external propulsion mechanism according to an embodiment of the present invention.

FIG. 8B shows a schematic elevation view of an L-car with an underlying external propulsion mechanism according to an embodiment of the present invention.

FIGS. 9A-9C show a schematic elevation view of a sensor and an actuator to stop and start the L-car according to an embodiment of the present invention.

FIG. 10 shows a schematic overhead view of a container carried on an L-car that may be moved from a main line to a side track having a connector rail and a platform according to an embodiment of the present invention.

FIG. 11 shows a schematic overhead view of a connector rail on a side track that pivots to permit a tractor to pull a container off an L-car car according to various embodiments of the present invention.

FIG. 12 shows a schematic elevation view of a container or semi-trailer carried on an L-car and pulled by a tractor modified to travel on rail according to an embodiment of the present invention.

FIG. 13 shows a schematic elevation view of a tractor backing up onto a raised deck to connect to a container or semi-trailer carried on an L-car according to an embodiment of the present invention.

FIG. 14 shows a schematic elevation view of a tractor backing up on a road to connect to a container or semi-trailer carried on an L-car according to an embodiment of the present invention.

FIGS. 15A-15C show a schematic overhead view of a segmented rail that includes articulated members with multiple joints or elements according to various embodiments of the present invention.

FIGS. 16A-16B shows a schematic overhead view of a fixture that couples two consecutive L-cars with a fixture having a hook-and-loop mechanism according to various embodiments of the present invention.

FIG. 17 shows a schematic overhead view of a straddling crane with a portable scaffolding and a power wincher to lift and turn an L-car onto a segmented rail according to an embodiment of the present invention.

FIG. 18 shows a schematic overhead view of sleeves and flanges to enclose tires or wheels of a tractor on rail according to various embodiments of the present invention.

### DETAILED DESCRIPTION OF THE PRESENT INVENTION

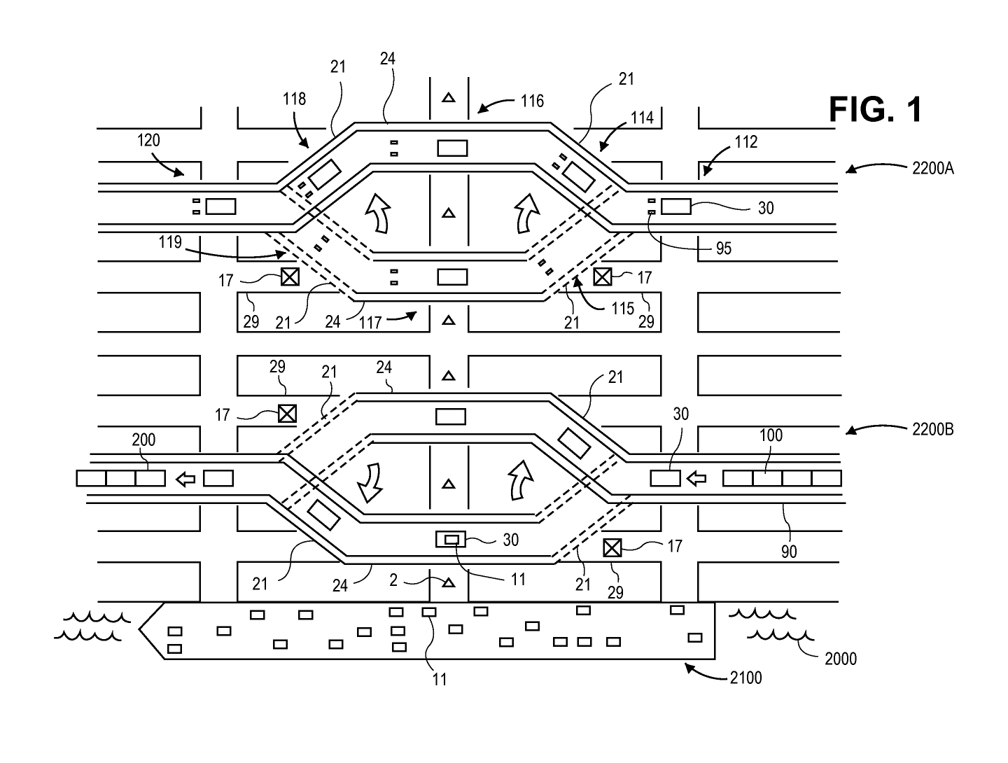

Freight may be carried in a container or semi-trailer 11 that is 10-56 feet long, 8-8.5 feet wide, and 4.25-13.5 feet high. As shown in an embodiment of the present invention in FIG. 1, an apparatus for and a method of transferring the freight between a mode of transportation (such as a cargo ship 2100 on a body of water 2000) and another mode of transportation (such as a tractor 17 on a road 29) may include an L-car 30 of the present invention on a railway spur 2200A, 2200B.

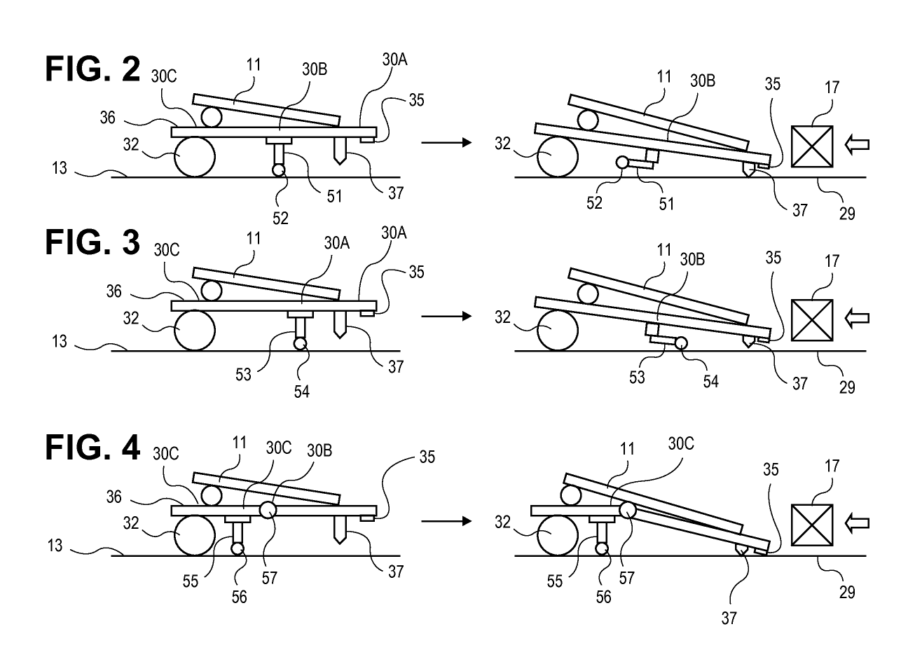

The L-car 30 may have a length of 25-44 feet (short), 45-95 feet (medium), or 96-115 feet (long). FIGS. 2-4 shows how a deck 36 of the L-car 30 may be tilted relative to an underlying rail 13 to load or unload the L-car 30. The deck 36 may be adapted to be at least one of the following: telescoping, articulated, jointed, hinged, rotatable, pivoting, swiveling, and flexible. As shown in FIG. 4, the deck 36 may include a joint or hinge 57 attached towards a mid-section 30B.

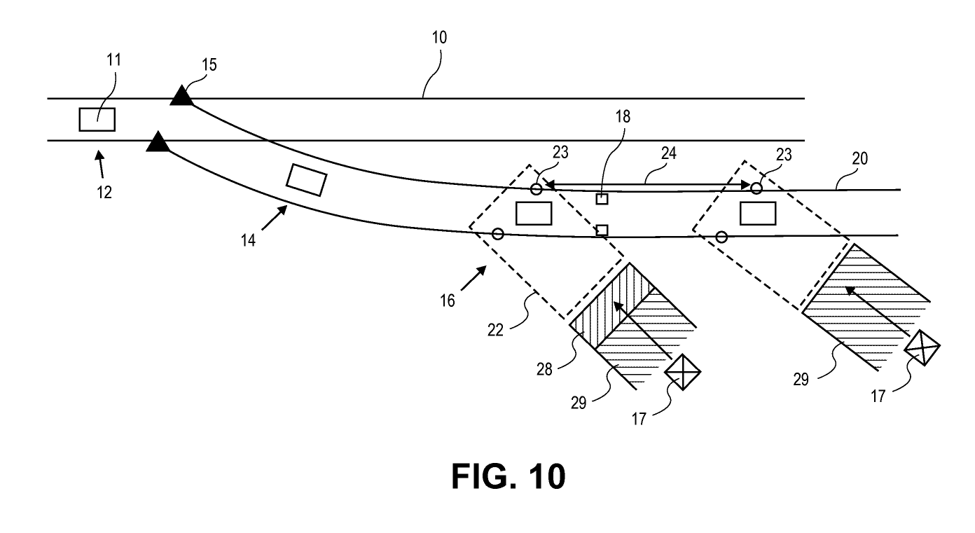

The L-car 30 may have a width of 9-10 feet. The deck 36 may include lateral sections that slide in/out or fold up/down. The width may be increased to 12-13 feet to facilitate access to the L-car 30 from a raised deck 28 or an adjacent road 29 for loading or unloading the freight as shown in FIG. 10 and FIGS. 13-14. The width may be reduced to 6-7 feet to facilitate storage of the L-car 30 in a railroad yard after unloading the freight.

As shown in FIGS. 6A-6B, the deck 36 may include two or more layers that differ in size and shape from each other. The multiple layers are adapted to be at least one of the following: move, slide, rotate, pivot, swivel, and bend horizontally and/or vertically, relative to each other.

An upper layer 36B and a lower layer 36A may tilt separately or together to adjust an inter-layer spacing from 0.3-1.0 foot (FIG. 6A), to 6.0-16.0 feet (FIG. 6B).

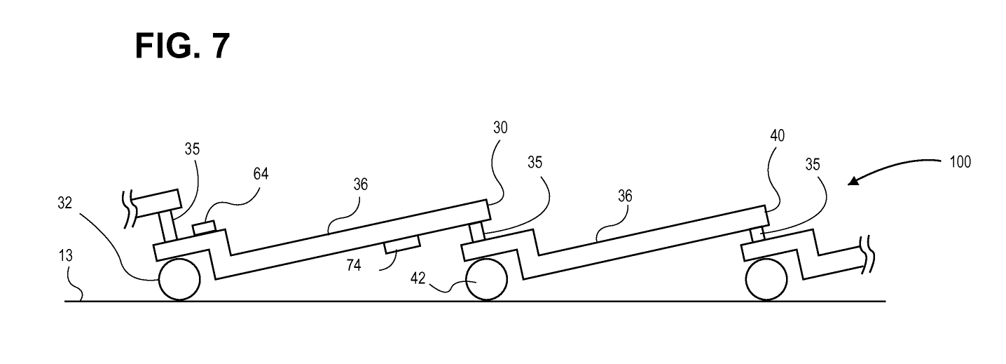

The deck 36 may include angles, curves, contours, unevenness, and textures. As shown in FIGS. 2-4, the L-car 30 may include a dolly 32 towards a rear section 30C, of the deck 36. 32. FIG. 7 shows how the deck 36 may include L-shapes to provide clearance around the dolly 32.

FIG. 7 shows how the deck 36 may be tilted (with a zig-zag or saw-tooth appearance as viewed from a side) when consecutive L-cars 30, 40 on the rail 13 are connected in a string 100 in a train.

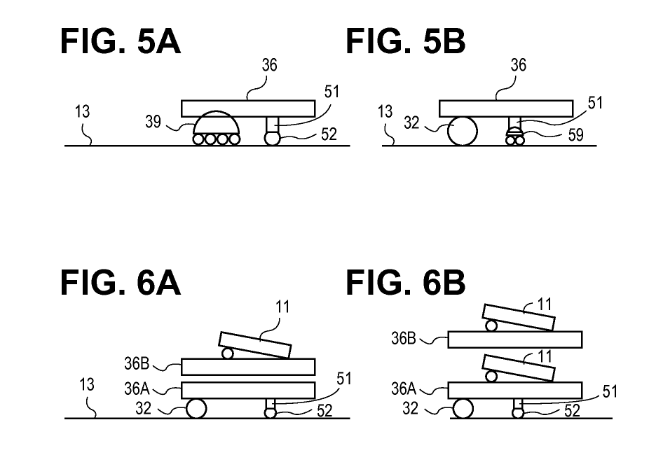

In an embodiment, the dolly 32 may include a single axle with oversized wheels having a diameter of 38-47 inches. In another embodiment as shown in FIG. 5A, the dolly 32 may include multiple axles, such as 4-6 axles, with undersized wheels having a diameter of 18-27 inches. In still another embodiment, the dolly 32 may concurrently include wheels with multiple diameters, such as 28-37 inches. In yet another embodiment, the dolly 32 may have no axle so that the wheels on opposing sides of the L-car 30 may shift or rotate independently. The absence of an axle allows the left and right wheels to be staggered relative to each other if desired. The absence of an axle allows the wheels to adjust to different gauge of the railroad as needed. A standard gauge for a track of a railroad in North American is 56.5 inches.

As shown in FIG. 5A, the dolly 32 may include a swiveling assembly 39 to swivel horizontally +/−55 degrees and vertically −/−25 degrees. The swiveling assembly 39 may include a ball-and-socket joint, such as with arrays of bearings that may be sealed, lubricated, temperature-controlled, and enclosed.

The dolly 32 may include a contact-maintaining mechanism, such as with variable-loaded springs, to ensure secure contact between the wheels and the underlying rail 13. When desired, some of the wheels of the dolly 32 may be lifted off the underlying rail 13.

As shown in FIGS. 2-4, the L-car 30 may include a fixture 35 at a front section of the deck 36, The fixture 35 may include a hook-and-loop mechanism. In one case, as shown in FIG. 16A, a hook fixture 35 at a front section 30A of a rear L-car 30 couples with a loop 300 at a rear section of a front L-car 40. In another case, as shown in FIG. 16B, the loop 300 at a front section of the rear L-car 30 couples with a hook fixture 35 at a rear section of the front L-car 40. The fixture 35 may swivel horizontally +/−40 degrees.

As shown in FIG. 7, the fixture 35 includes a load-balancing mechanism, such as with variable-load springs, to distribute weight evenly across consecutive L-cars 30, 40 that are coupled together. The fixture 35 accommodates pitch, roll, and yaw, as the coupled consecutive L-cars 30, 40 move along the rail 13. The fixture 35 accommodates dynamic loading that may result from a change in slack between the coupled consecutive L-cars 30. 40.

In other embodiments of the present invention, the fixture 35 of the L-car 30 includes at least one of the following: a universal joint (that pivots in 2 or 3 axes), a clasping/unclasping mechanism, a locking mechanism, a quick-release mechanism, and a coupler/hitch. The fixture 35 may have a low profile.

In an embodiment of the present invention, the fixture 35 may include a self-aligning head, a U-shaped receptacle, a 270-degree pivoting pin, a quick-release locking system, two sliding skid (or pressure) plates, and spherical axial bearings.

As shown in FIGS. 2-4, the L-car 30 may include a landing gear between the dolly 32 and the fixture 35, such as towards a mid-sect ion 30B of the L-car 30. The landing gear may include one or more of the following: a hand crank mechanism, a motorized power winch assembly, a selectable bi-directional ratcheting device, an internal braking device, and counterweights.

In one case, both the dolly 32 and the landing gear include wheels that share the same diameter as shown in FIG. 13. In other cases, the landing gear may include a mini dolly 52, 54, 56 as shown in FIGS. 2-4. In one embodiment as shown in FIG. 5B, the mini-dolly 52, 54, 56 may include multiple, such as 2-3, mini-axles. In another embodiment, the mini-dolly 52, 54, 56 may have no mini-axle.

As shown in FIG. 5B, the mini-dolly 52, 54, 56 may include a swiveling assembly 59 to swivel horizontally and vertically. The swiveling assembly 59 may include a ball-and-socket joint, such as with arrays of bearings that may be sealed, lubricated, temperature-controlled, and enclosed.

In another case as shown in FIGS. 2-3, the landing gear may include folding legs 51, 53 that may be attached below the deck 36 of the L-car 30, such as with a bracket. The landing gear may include cross-members and braces between the legs 51, 53 to resist transverse as well as bending forces. The legs 51, 53 may pivot around a hinge, or joint, attached below the deck 36 of the L-car 30. The folding legs 51, 53 may tilt the deck 36 of the L-car 30.

As shown in FIG. 4, the landing gear of the L-car 30 may include telescoping legs 55 attached below the deck 36 of the L-car 30, such as with a bracket. As shown in FIG. 14, the telescoping legs 55 may tilt the deck 36 of the L-car 30.

The L-car 30 may include a jack 37 that is attached towards the front section 30A of the L-car 30. The jack 37 may be located aft of the fixture 35. The jack 37 may include a base plate that is broad. The base plate is self-leveling, such as by pivoting or swiveling, and may rest on uneven ground or on the rail 13. The jack 37 may include two or more vertical members with integrated cross-braces. In different embodiments of the present invention, the jack 37 spans a width equivalent to 40-80 or 80-120% of the width of the deck 36 of the L-car 30. In another case, the L-car 30 may include two or more jacks 57.

The jack 37 may include at least one of the following: a manual crank mechanism, a motorized power winch assembly, a screw mechanism, a locking mechanism, a release mechanism, a selectable bi-directional ratcheting device, an internal braking device, and counterweights. The jack 37 may tilt the deck 36 of the L-car 30. As shown in FIGS. 2-4, the jack 37 may raise or lower the front section 30A of the deck 36 of the L-car 30.

In one embodiment, the jack 37 operates independently of the landing gear that may support the L-car 30. For example, the jack 37 may be deployed before adjusting or detaching the landing gear. Alternatively, the landing gear may be deployed before adjusting or detaching the jack 37.

In another embodiment, the jack 37 operates in conjunction with the landing gear that may support the deck 36 of the L-car 30. For example, the jack 37 may be deployed before retracting or folding the landing gear. Alternatively, the jack 37 may be deployed before extending or unfolding the landing gear.

In another embodiment of the present invention, the L-car 30 may include an articulated deck 36 with two or more joints, or hinges, 57 attached at various portions of the deck 36 to change configurations. The multiple joints or hinges 57 may tilt the deck 36 of the L-car 30. In a first configuration, the multiple joints or hinges 57 are pivoted upwards (until the front section 30A of the deck of the L-car 30 becomes horizontal). In a second configuration, the multiple joints or hinges 57 are pivoted downwards so as to lower the front section 30A of the deck 36 of the L-car 30 (and tilt the deck 36 forward) for unloading the container or the semi-trailer 11.

In still another embodiment of the present invention, the L-car 30 may include a spine instead of a deck to reduce a tare weight of the L-car 30. The spine is reinforced with cross-members and braces. Two separate and parallel plates may be integrated with the spine to support the container or the semi-trailer 11. The plates may include lowered structures, such as channels, or raised structures, such as railings, to guide the container or the semi-trailer 11 during transfer on and off the L-car 30. In one case, the spine may be articulated, jointed, hinged or telescoping to adjust the length of the L-car 30.

A landing gear and a jack 37 may be attached below the spine. The landing gear may include legs with mini-dollies or mini-wheels. The legs may be telescoping, bendable, or fixed. The legs may be attached below the spine of the L-car 30, such as with a bracket. The legs may be stored within a recessed cavity. The landing gear and the jack 37 may tilt the spine of the L-car 30.

As shown in FIG. 7, the L-car 30 may be assembled with other L-cars as part of the string 100 in an arriving or coming train. In one embodiment of the present invention, the deck 36 of the L-car 30 (from rear to front of the deck 36) in the string 100 of L-cars may include an upward (positive-angled) tilt such that the deck 36 near the rear section 30C of the L-car 30 is lower than the deck 36 near the front section 30A of the L-car 30. The upward tilt may include +15 (+/−5) degrees. The deck 36 near the rear section 30C of the L-car 30 may be placed 0.5-2.5 feet above a top of rail 13 while the deck 36 of the L-car 30 near the front section 30A of the L-car 30 may be placed 2.5-4.5 feet above the top of rail 13.

In another embodiment of the present invention, the deck 36 of the L-car 30 (from the rear section 30C to the front section 30A) in the string 100 of L-cars may be placed level (and parallel) relative to the top of the rail 13 below the L-car 30. The tilt of the level deck 36 may include 0 (+/−5) degrees.

In still another embodiment of the present invention, the deck 36 of the L-car 30 (from the rear section 30C to the front section 30A) in the string 100 of L-cars may include a downward (negative-angled) tilt such that the deck 36 near the rear section 30C of the L-car 30 is placed higher than the deck 36 near the front section 30A of the L-car 30. The downward tilt may include −15 (+/−5) degrees.

The L-car 30 may include a self-leveling mechanism, such as a gyroscopic device with a control computer, to monitor and, as desired, to maintain a consistent tilt (whether positive, level, or negative) of the deck 36 of the L-car 30 within a certain tolerance.

The railway spur 2200A, 2200B may be divided into sectors or zones. Staging location 112 is a shared entry (arriving or coming) zone. Locations 116, 117 are distinct load or unload zones (such as called “A” 116 and “B” 117). Location 120 is a shared exit (departing or going) zone. In one embodiment of the present invention, a first set of switches directs the L-car 30 upon entry, to shunt location 114 or 115. In another embodiment of the present invention, a second set of switches directs the L-car 30 upon exit, to shunt location 118 or 117. Then the L-cars 30 may be connected into clusters and into the string 200 of the train on the departing or going track.

A first set of zones may be arranged in parallel while a second set of zones may be arranged in series. The first set of zones includes the distinct load or unload zones (such as called “A” 116 and “B” 117). The second set of zones includes the shared entry (arriving or coming) zone 112 and the shared exit (departing or going) zone 120.

A network of sensors 95, located along the railway spur 2200A, 2200B, may operate in conjunction with a network of actuators located along the railway spur 2200A, 2200B, to align and position the L-car 30 with sufficient precision in the various sectors or zones. The sensors 95 may function individually or in groups, such as pairs as shown in FIG. 1.

The sensors 95 may be contact, inductive, or capacitive. The actuators may be pneumatic, hydraulic, or motorized. A grid of switches may be located between the sectors or zones. The switches may be mechanical, electro-optical, or magnetic. The switches may be controlled by one or more computers that may be standalone, localized, centralized, remote, or cloud.

The zones with corresponding locations are designated in a layout. The layout is customized depending on usage type, container owner, or freight customer. Many configurations are compatible with the present invention.

In an all-or-nothing configuration, as shown on railway spur 2200A in FIG. 1, the first and second set of switches are selected to permit a higher priority L-car 30 (or hotshot) to move completely through locations 112, 114, 116, 118, and 120 to arrive, load (or unload), and depart sequentially while a lower priority L-car waits its turn at locations 115, 117, and 119.

Such a configuration permits unequal priority L-cars to load or unload with a last-in-first-out (LIFO) logic. For example, higher priority L-cars that arrive later may be permitted to overtake (move ahead of) lower priority L-cars that arrive earlier. Such a configuration also permits L-cars (that do not need to load or unload) to bypass other L-cars (that do need to load or unload). Frequency of switching is reduced which may be desirable, but efficiency may become lower which may not be desirable.

In a taking-turns configuration, as shown on railway spur 2200E in FIG. 1, the first and second set of switches are selected to permit one L-car 30 to move through locations 112, 114, and 116 to arrive and load (or unload) while concurrently permitting another L-car to move through locations 117, 119, and 120 to load (or unload) and depart.

Such a configuration permits equal priority L-cars to load or unload with a first-in-first-out (FIFO) logic. Frequency of switching is increased which may not be desirable, but efficiency may become higher which may be desirable

As shown in FIG. 1, an arriving or coming track, such as from a higher elevation, may accumulate a quantity, such as 75-225, of L-cars 30 assembled in the string 100 in the train. While assembled in the string 100 in the train as shown in FIG. 7, the dolly 32 towards the rear section 30C of the L-car 30 may ride on the rail 13 of the track. The landing gear of the L-car 30 may be stowed, such as folded or retracted inside a cavity with a hatch or cover. The landing gear of the L-car 30 may include 2 legs connected with an axle. Each leg may have a small wheel.

In various embodiments, the individual L-car 30 may move towards the buffer, staging, load, unload, and bypass locations. The cluster of L-cars 30 may move passively (without power) down a slope on the coming track.

The L-car 30 may move actively (with power) with an external propulsion mechanism, to one or more sectors or zones along the railway spur 2200A, 2200B. Structural members having various shapes, sizes, dimensions, and attachment locations to the L-car 30 may connect the L-car 30 to one or more external propulsion mechanisms. The external propulsion mechanism may be located above, below, or adjacent to the railway spur 2200A, 2200B.

The external propulsion mechanism may include a series of connection devices integrated with at least one of the following adjustment devices, control devices, and power devices. The connection devices are closed-circuit or endless and may include belts, cables, or chains, The adjustment devices are active and may include springs, tensioners, pulleys, cams, gear trains, and drive shafts. Control devices that are active may include rails, pins, or rollers, such as to support, align, or guide the belts, cables, or chains. Control devices that are passive may include grooves or channels, such as to support, align, or guide the belts, cables, or chains. The power devices may include electric motors, with back-up or fail-safe systems, to drive the belts, cables, or chains, in closed circuit, such as at constant speeds.

The L-car 30 may include one or more attachment devices, such as clamps or jaws. As desired, the attachment device progressively engages, such as grips, the driven endless belts, cables, or chains in order to couple, synchronize, and propel the L-car 30, such as forward. Alternatively, the attachment device progressively disengages, such as releases, the driven endless belts, cables, or chains in order to decouple the L-car 30. Then, brakes may be applied to the wheels in the dolly to stop the L-car 30 even as the endless belts, cables, or chains continue to be driven in closed circuit, such as at constant speeds, by the power devices.

After the coming train arrives over the railway spur, such as 2200B, the string 100 may optionally be separated nearby into a cluster, such as of 5 L-cars 30, in a buffer location. The landing gear of the lead L-car 30 may be deployed, such as unfolded or extended to ride on the rail 13.

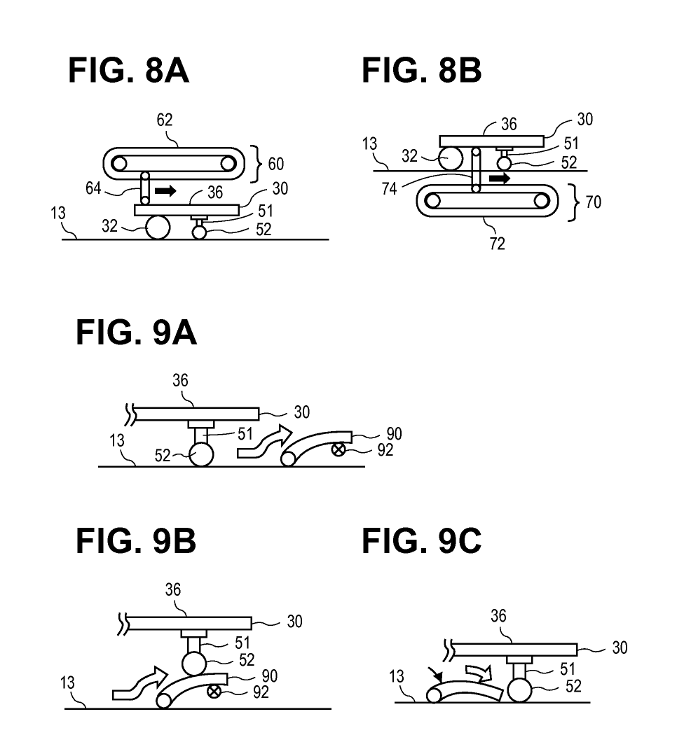

As shown in FIG. 8A, the L-car 30 may include a hinged rod or arm 64, such as above the rear section 30C of the deck 36, to deploy and attach to an overhead external propulsion mechanism such as a power wincher 60. The structural member 64 is shown in a stowed or retracted mode in FIG. 7 and in a deployed or extended mode in FIG. 8A. The power wincher 60 may engage the extended arm 64 and may move, such as push or pull, the cluster of L-cars 30, such as forward, along the rail 13.

Upon arrival at staging location 112, the cluster of L-cars 30 may be separated into individual L-cars 30. The stand-alone L-car 30 may ride on the rail 13 with both the dolly 32 and the landing gear.

The L-car 30 may include a cross-piece 74, such as below the mid-section 30B of the deck 36, to attach to an underlying external propulsion mechanism to move, such as push or pull, the L-car 30 forward along the rail 13. The structural member 74 is shown in a stowed or retracted mode in FIG. 7 and in a deployed or extended mode in FIG. 8B.

As shown in FIG. 8B, the hinged cross-piece 74 may be deployed from the deck 36, such as below the mid-sect ion 30B of the deck 36 of the L-car 30. The cross-piece 74 may be attached to the landing gear of the L-car 30. The cross-piece 74 may include a hook. An external propulsion mechanism, such as a convey or belt, 70 may be located below the L-car 30 or the rail 13. The conveyor belt 70 may include a V-shaped puller structure to catch the hook of the cross-piece 74. Then, the conveyor belt 70 may take over from the power wincher 60 in the staging location and may move, such as push or pull, the L-car 30 to the entry zone 112.

As shown in FIG. 9A, an axle-rest arm structure 90 may serve as both a sensor and an actuator. The axle-rest arm structure 90 may protrude slightly above the rail 13 at the entry zone 112. When the L-car 30 reaches the entry zone 112, the cross-piece 74 may push, slide, and climb up the axle-rest arm structure 90. As a result, the hook of the cross-piece 74 becomes disengaged from the V-shaped puller structure of the underlying conveyor belt 70, thus stopping the L-car 30 and allowing the cross-piece 74 to come to a rest on top of the axle rest arm structure 90, thus un-catching the hook from the V-shaped puller structure to stop the L-car 30. The axle-rest arm structure 90 is supported in a raised position by the release pin 92.

Next, a load or unload zone (such as “A” 116 or “B” 117) as shown in FIG. 1 may be selected. The L-car 30 may be rearranged, sorted, or classified by L-car 30 owner (or company), origination point, intermediate point, destination point, or railroad freight car type. Then, a structural member that is removable or pivotable may be shifted to connect to the selected load or unload zone.

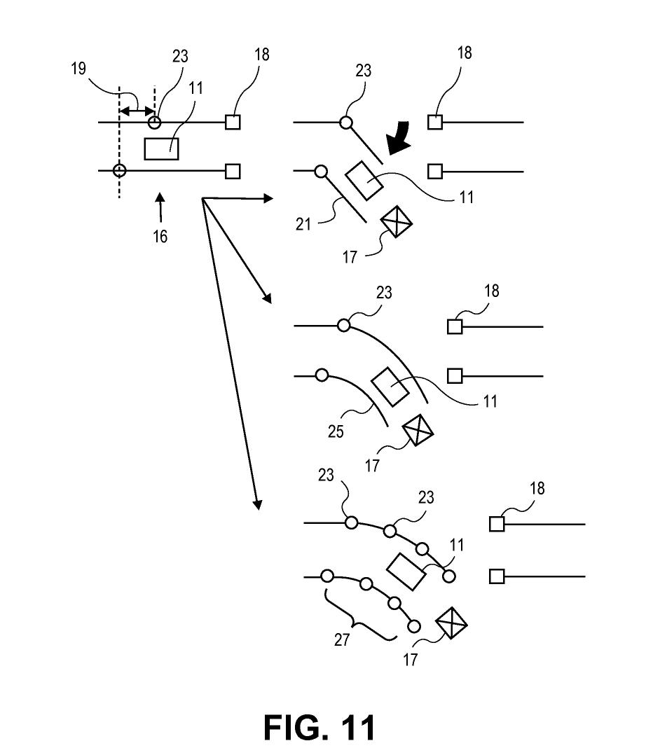

As shown in FIG. 10, the container or semi-trailer 11 traveling on an L-car 30 on a main rail line 10 may proceed through locations 12, 14, and 16 by being switched at a junction 15 to a side track 20 that includes a connector rail, such as a segmented rail, 21 as shown in FIG. 11. In one case, the side track 20 may be a dead-end spur that is predominantly parallel to the main line 10. In another case, the side track 20 may be a closed loop that eventually connects back to the main line 10. In one case, the segmented rail 21 may include a straight member with a length, such as 3-12 feet. The segmented rails 21 for the two rails may differ in size, shape, or design.

As desired, the side track 20 may include a periodic series of segmented rail 21. The periodicity may correspond to the length of the L-car 30 in FIG. 7. The periodicity of the segmented rail 21 may be regular, such as to accommodate fixed lengths of the L-car 30, or irregular, such as to accommodate variable lengths of the L-car 30.

The segmented rail 21 in the periodic series may be contiguous (without any spacing). The segmented rails 21 in the periodic series may be non-contiguous, such as separated by a spacing 24 between consecutive hinges 23. The spacing 24, when present, may be fixed. The spacing 24, when present, may be variable.

In one case, as shown in FIG. 11, the segmented rail 21 may be pivotable at a hinge 23. The hinges 23 on the two rails may be separated by an offset distance 19 along the rail. The segmented rail 21 for the two rails may differ in length. In a close position, the segmented rail 21 is aligned with the side track 20 with a slant angle of zero degree. In an open position, the segmented rail 21 is slanted relative to the side track 20 with a slant angle, such as 30-60 degrees. In different embodiments, the segmented rail 21 may include features such as a clasping mechanism, a locking mechanism, or a quick-release mechanism.

The operation, such as pivoting, of the hinge 23 may be performed pneumatically, hydraulically or electrically. If desired, the operation, such as pivoting, of the hinge 23 may be performed manually, such as by pulling, such as on a chain that is attached, permanently or temporarily, to the segmented rail 21, such as with a hook.

In another case, the segmented rail 21 may be removable at the hinge 23. In a close position, the segmented rail 21 is aligned with the side track 20 to the joint 18. In an open position, the segmented rail 21 is disconnected (or separated) between the hinge 23 and the joint 18, removed, and replaced with a curved indent 25 that is slanted, at its end (or tip), relative to the side track 20 with a slant angle of about 45 degrees. The curved indent 25 for the two rails may differ in size, shape, or design.

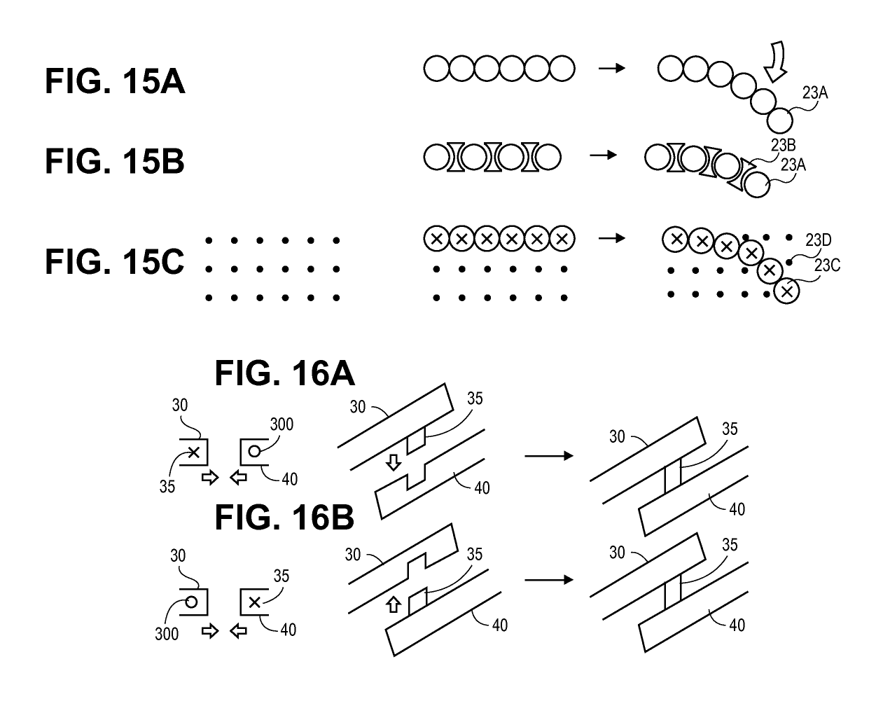

FIG. 15A shows a segmented rail 21 that includes an articulated member 27 formed from multiple joints 23A, such as having coin shapes, connected without spacers. FIG. 15B shows the segmented rail 21 that includes an articulated member 27 formed from multiple joints 23A nested with spacers, 23B. FIG. 15C shows the segmented rail 21 formed by placing individual or distinct elements 23C near or next to each other at discrete locations 23D in a particular arrangement, such as in an array. The segmented rail 21 for the two rails may differ in size, shape, or design.

The articulated member 27 may be pivotable at the multiple joints 23. The curvature of the articulated member 27 may be increased (to a smaller radius) or decreased (to a larger radius) by adjusting the joints 23 in the articulated member 27 relative to each other. In a closed position, the articulated member 27 is aligned in a straight line (to an infinitely large radius) with the side track 20. In an opened position, the articulated member 27 is curved at its end (or tip) relative to the side track 20 with a slant angle, such as 45 degrees. The articulated member 27 for the two rails may differ in size, shape, or design. As needed, the articulated member 27 may further physically conform to an underlying change in topography, such as a slope.

As shown in FIG. 10, one hinge 23 of the segmented rail 21 may be connected to an underlying block or platform 22. The platform 22 may be formed from concrete. The platform 22 may be located next to rails in the side track 20.

In one situation, the platform 22 may be discontinuous along an axis that is parallel to the rails in the side track 20. In one case, the gaps between (the hinges 23 connected to) the consecutive platforms 22 may be constant (or fixed). In another case, the gaps between (the hinges 23 connected to) the consecutive platforms 22 may be variable.

In another situation, instead of being distinct or separated, the platforms 22 may be connected or merged along the axis that is parallel to the rails in the side track 20.

In one case, the segmented rail 21 may be slidable along part, or all, of its length. In one situation, the segmented rail 21 may slide or glide, on, over, or across a plate. The plate may be formed from metal that has been hardened or strengthened. The metal may reduce sliding friction, when compared to concrete. The plate may be attached to the underlying block or platform 22.

The platform 22 may vary in shape. The platform 22 may vary in size, such as lateral dimensions. The platform 22 may vary in thickness. The platform 22 may be partially buried or located entirely below grade. In one case, the plate may have the same shape and size, such as lateral dimensions as the platform 22.

After the segmented rail 21 has been shifted into place, an electric screw motor may withdraw a release pin 92. A spring helps the axle-rest arm structure 90 to lean forward. The cross-piece 74 slides and climbs down the top of the axle-rest arm structure 90. Upon re-catching the hook on the V-shaped puller structure, the conveyor belt 70 resumes pulling the L-car 30 forward.

Subsequently, the L-car 30 may travel over the segmented rail 21 to the selected load or unload zone (such as “A” 116 or “B” 117) as shown in FIG. 1. The container or semi-trailer 11 may be removed from a mode of transportation, such as the cargo ship 2100, with a lift-and-turn mechanism, such as a straddling crane, 2 and placed on the deck 36 of the L-car 30, at location 116, 117, along the railway spur 2200A.

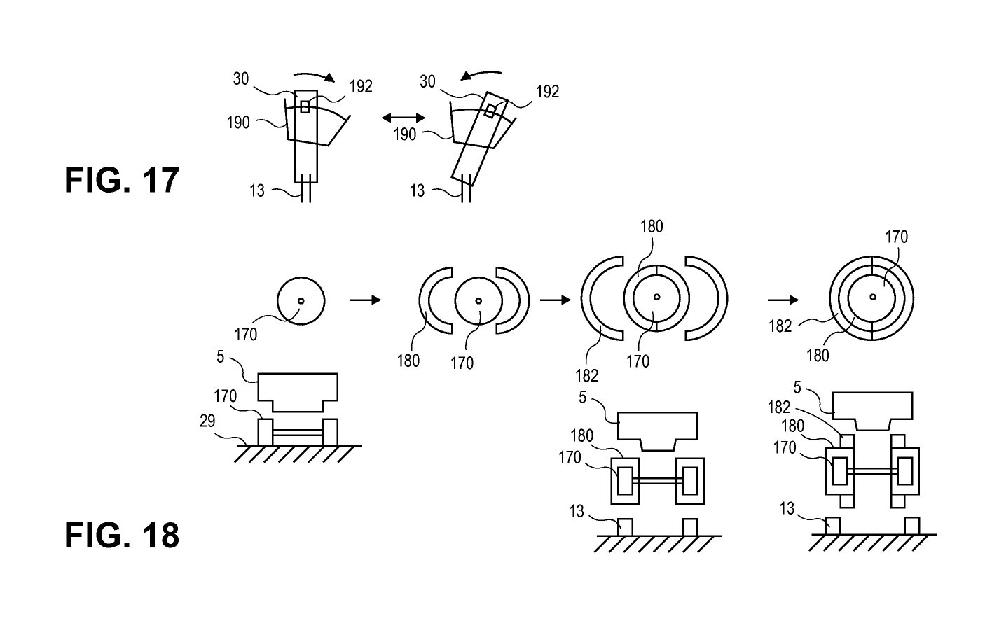

As shown in FIG. 17, the straddling crane 2 may include a portable scaffolding 190 to align, secure, and support the L-car 30. The portable scaffolding 190 may include a mechanism to adjust size, such as length, width, depth, height, and thickness. The portable scaffolding 190 may include multiple reinforced extensions or legs near the periphery, such as at four corners. The legs may include a telescoping, ratcheting, and locking mechanism. The legs may include a baseplate to support the L-car 30. The legs may include a dolly, such as with wheels, to move the L-car 30. The straddling crane 2 may include a transfer mechanism, such as screw drives, chains, hooks, and a power wincher 192, to grasp, lift, turn, and move the container or semi-trailer 11 on and off the L-car 30.

The straddling crane 2 may perform sequences of operations on the L-car 30 or the container or the semi-trailer 11. The operations may include one or more of the following: moving, lifting, turning, pivoting, swiveling, shifting, replacing, lowering, and leveling. The L-car 30 on the segmented rail 23, with or without the container or the semi-trailer 11, may be transferred or moved, such as with the straddling crane 2 over and across the plate on the platform 22. In one case, the L-car 30 is lifted and turned, such as with the straddling crane 2. In another case, the L-car 30 is rolled on the segmented rail 23, such as with the straddling crane 2. In still another case, the L-car 30 is dragged on, or over, and across the plate (not shown) on the platform 22, such as with the straddling crane 2. In yet another case, the container or the semi-trailer 11 carried on the L-car 30 is lifted and turned, such as with the straddling crane 2. In a further case, the container or the semi-trailer 11 carried on the L-car is shifted and lowered, such as with the straddling crane 2.

Then, another segmented rail 21 may be shifted, such as to connect to the unload zone, such as the road 29. The electric screw motor withdraws the release pin 92 so that the spring can help the axle-rest arm structure 90 lean forward, letting the cross-piece 74 fall off the top of the axle-rest arm structure 90, thus re-catching the hook on the V-shaped puller structure on the conveyor belt 70 to again pull the L-car 30 forward. The L-car 30 is pulled onto the segmented rail 21 to the unload zone.

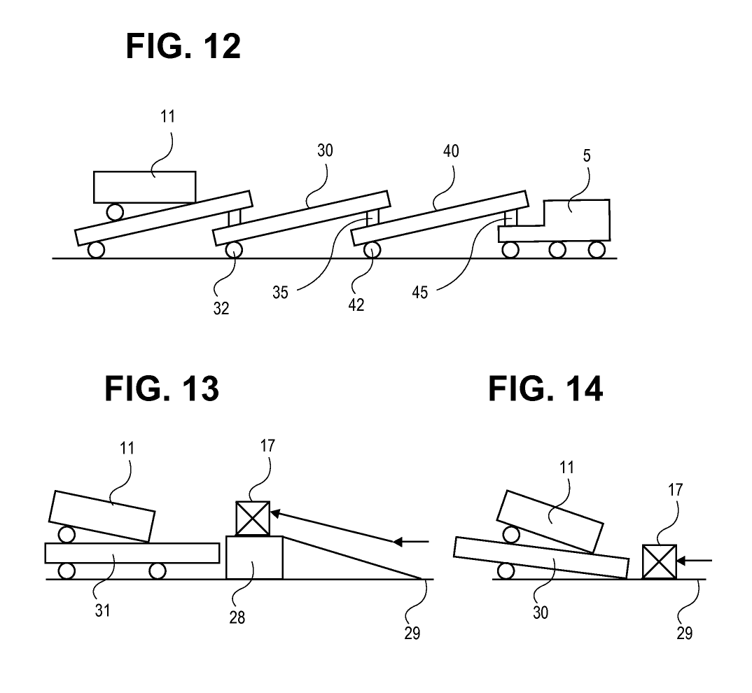

Next, the container may be unloaded from the L-car 30 in the unload zone. To permit mobility, the container may be placed on a chassis with 2 axles, such as with a total of 4 wheels (usually located near and below the 4 corners of the container) so as to roll on a road 29. The semi-trailer 11 already has mobility because it includes 2 axles near the rear. In one case, each axle may have a pair of double wheels (or dualies) near each end of the axle so as to roll on the road 29. A tractor 17 may back up on the road 29 adjacent to the load or unload zone (such as “A” 116 or “B” 117) onto a raised deck 28 as shown in FIG. 10 and FIG. 13. The connection between the tractor 17 and the container or the semi-trailer 11 may include the fixture 35 that may connect two consecutive L-cars 30 as shown in FIG. 12. Then, the tractor 17 may pull the container or the semi-trailer 11 off the L-car 30.

Alternatively, the legs of the landing gear are stowed, such as by folding under the deck 36, such as with a hand crank, to tilt the deck forwards and downwards, such as by 10-30 degrees. When the deck 36 is lowered near the top of the rail 13, the tractor 17 may back up directly on the adjacent road 29 as shown in FIG. 10 and FIG. 14 and the raised deck 28 would not be needed. The tractor 17 may be used to connect to the unloaded container, such as on the chassis, or the semi-trailer 11 that is on the flatcar 31 or L-car 30. The connection between the tractor 17 and the container, such as on the chassis, or the semi-trailer 11 may also include the same fixture 35, as described previously, that connects two L-cars 30, 40.

Subsequently, the tractor-trailer (a combination of the tractor 17 and one or more containers or semi-trailers 11) may continue its journey on the road 29. The trip of the tractor-trailer to one or more destination points may include a distance of less than 1,000 miles, such as 100-300 miles, to balance efficiency with flexibility.

Next, as shown in FIGS. 2-4, the legs of the landing gear of the L-car 30 are deployed, such as by unfolding from under the deck 36, such as with the jack 37 or the hand crank, to raise and support the deck 36 again. Then, the L-car 30 leaves on a departure or going track. The L-car 30 rides on the rail 13 of the departure or going track with the dolly 32 and the landing gear. The L-car 30 may be optionally assembled into a cluster, such as of 5 L-cars 30. Then, the L-cars 30 in the cluster may be assembled into the string 200 in the train on the departure or going track.

In an embodiment of the present invention, the container or the semi-trailer 11 may be left on the L-car 30. Then, the tractor 17 couples to one or more L-cars 30, such as in a cluster or string, and proceeds on the rail 13 (instead of on the road 29). As shown in FIG. 18, the tires or wheels 170 of the tractor 17 may be enclosed within sleeves 180 to travel on the rail 13. The sleeves 180 may include two or more curved sections that are assembled and secured to each other, such as with screws, bolts, and threading. The sleeves 180 may be formed from a material, such as steel, that has been hardened and strengthened. The non-driven wheels may be enclosed within sleeves 180 that include flanges 182 that are guided by the rail 13. The motor driven wheels may be enclosed within sleeves 180 without flanges 182 to allow turning sideways while on the rail 13. A railroad may include a track gauge such as 56.5 inches. The tractor 17 may include trackwidths, such as 96-102 inches. As needed, an apparatus may be attached to the axles, tires and/or wheels of the tractor 17 to accommodate the gauge of the railroad. As needed, the apparatus may adjust and control caster, camber, and toe-in of the wheels of the tractor 17. Alternatively, a tractor 17 with a narrow trackwidth, such as 50-60 inches, may pull one or more L-cars 30 on rail.

Many embodiments have been set forth to provide a thorough understanding of the present invention. However, one skilled in the art may make equivalent substitutions. The detailed description of the present invention should be taken as illustrative and not limiting since the scope of the present invention should be determined by the claims that follow.

We claim:

1. An apparatus for transferring freight among different modes of transportation comprising:
a railway spur;
zones disposed along said railway spur;
an L-car disposed over said railway spur to carry said freight;
a tractor disposed on rail to move said L-car along said railway spur, said tractor including wheels with sleeves and flanges;
sensors and actuators disposed along said railway spur to start and stop said L-car in said zones; and
connector rails disposed along said railway spur to direct said L-car onto roads adjacent to said railway spur.

2. The apparatus of claim 1 wherein said zones comprise a first set of zones disposed in parallel along said railway spur.

3. The apparatus of claim 2 wherein said first set of zones comprises a loading zone and an unloading zone.

4. The apparatus of claim 1 wherein said zones comprise a second set of zones disposed in series along said railway spur.

5. The apparatus of claim 4 wherein said second set of zones comprises a shared entry zone and a shared exit zone.

6. The apparatus of claim 1 wherein said L-car comprises:
a deck to carry said freight wherein said freight comprises a container or semi-trailer;
a dolly disposed below a rear section of said deck;
a landing gear disposed below a mid-section of said deck;
a fixture disposed below a front section of said deck; and
a jack disposed below said front section of said deck.

7. The apparatus of claim 6 further comprising a hinge disposed at a mid-section of said deck of said L-car.

8. A method of transferring a container with an L-car comprising:
separating said L-car from a first cluster or string of L-cars on an arriving track;
moving said L-car along a railway spur to an entry zone;
stopping said L-car at said entry zone;
switching said L-car to a first connector rail;
pivoting said first connector rail;
moving said L-car along said first connector rail to a loading zone;
loading a container onto said L-car with a straddling crane;
switching said L-car to a second connector rail;
pivoting said second connector rail;
moving said L-car along said second connector rail to an unloading zone;
unloading said container from said L-car with said straddling crane;
moving said L-car along said railway spur to an exit zone;
stopping said L-car at said exit zone;
assembling said L-car into a second cluster or string of L-cars on a departing track; and
pulling said second cluster or string with a tractor disposed on rail.

9. The method of claim 8 wherein said moving said L-car along said railway spur to said entry zone is performed by an external propulsion mechanism.

10. The method of claim 8 wherein said unloading said container from said L-car comprises tilting a deck of said L-car and moving said container off said deck onto a road adjacent to said railway spur.
